(19) United States
(12) Patent Application Publication
(10) Pub. No.: US 2021/0016816 A1
(43) Pub. Date: Jan. 21, 2021

(54) TRANSPORT DEVICE AND METHOD

(71) Applicant: Robert Bosch GmbH, Stuttgart (DE)

(72) Inventors: Bertram Schillinger, Lauf (DE); Jochen Pfister, Heidelberg (DE); Joerg Baur, Karlsruhe (DE); Norbert Martin, Achern (DE); Stefan Groh, Buehlertal (DE)

(21) Appl. No.: 16/975,108

(22) PCT Filed: Jan. 12, 2019
(86) PCT No.: PCT/EP2019/050727

§ 371 Date: Aug. 21, 2020

(30) Foreign Application Priority Data
Feb. 22, 2018 (DE) 10 2018 202 711.0

(51) Int. Cl. B62B 5/00; B62B 7/04; B62B 9/20; B62B 9/08

(52) U.S. Cl. CPC B62B 5/0069; B62B 7/044; B62B 5/0033; B62B 9/08; B62B 9/20

(57) ABSTRACT

The invention relates to a transport device (100), more particularly a pram (102), having at least three wheels (116, 118, 120) for moving on a surface (180, 182) and having a handle (110) for a user, wherein at least one wheel of the at least three wheels is designed as a drive wheel (122, 124, 126), which can be driven under electromotive power by means of an associated electrical drive unit (140, 142, 144), in order to permit an at least partial electromotive support to the manual pushing or pulling operation of the transport device by the user on the surface, wherein the transport device is provided with at least one acceleration sensor (172, 174) and a predefined braking torque (ΔFₘₒₜ) can be applied periodically to the transport device in pushing or pulling operation by means of the electrical drive unit and wherein a control device (170) assigned to the at least one acceleration sensor is designed to analyse the acceleration values (ax) from the at least one acceleration sensor to detect a presence or absence of the user at the transport device (100) and to regulate the electric drive unit in dependency thereon.

### BACKGROUND OF THE INVENTION

The present invention relates to a transport device, in particular a stroller, having at least three wheels for moving on a surface and having a handle for a user, wherein at least one wheel of the at least three wheels is designed as a drive wheel which can be electromotively driven by means of an associated electric drive unit in order to enable at least partial electromotive support of a manual pushing or pulling operation of the transport device by the user on the surface. The invention moreover has at its subject matter a method for identifying the presence of a user at a transport device, in particular at a stroller, having at least three wheels for moving on a surface and having a handle for the user.

Transport devices designed as strollers with active support for a user in the pushing or pulling operation by means of electromotively drivable drive wheels are known from the prior art. For safety reasons, a drive system of a transport device, in particular a stroller of this type, can be designed to identify the possible absence of a user or the release of the stroller by the user so that accidents caused by a stroller continuing to move independently and in an uncontrolled manner can be at least substantially prevented. In this case, electrified strollers are known, in which the presence of a user can be detected by at least one force sensor.

Moreover, strollers with electric support of the pushing and pulling operation are known, in which the electromotive support is only active so long as an actuating handle, actuating lever or the like on the handle of the stroller, which can be actuated for the purpose of activation, is actuated by the user. If the actuating handle is released due to the absence of a user, it returns automatically to an associated neutral position and the stroller is braked automatically.

Furthermore, in the case of rail vehicles, so-called dead man's switches are commonly used, in which a switch element is to be periodically operated by the user or driver. If this does not occur, the vehicle is promptly automatically decelerated until it reaches a standstill.

### SUMMARY OF THE INVENTION

The invention relates to a transport device, in particular a stroller, having at least three wheels for moving on a surface and having a handle for a user. At least one wheel of the at least three wheels is designed as a drive wheel which can be electromotively driven by means of an associated electric drive unit in order to enable at least partial electromotive support of a manual pushing or pulling operation of the transport device by the user on the surface. At least one acceleration sensor is provided on the transport device and a predetermined braking torque can be periodically applied to the transport device during the pushing or pulling operation by means of the electric drive unit, wherein a control device associated with the at least one acceleration sensor is designed to evaluate the acceleration values of the at least one acceleration sensor to identify the presence or absence of the user at the transport device and to control the electric drive unit as a function thereof.

Consequently, under all usage conditions of the transport device, which is designed, in particular, as a stroller, reliable identification of the absence of a user or the presence of a user is possible without additional sensor equipment which increases the wiring complexity. Alternatively, the transport device can also be a wheelbarrow, a dolly, a waste disposal container, in particular a garbage can, or the like. The pulse-like, short and preferably comparatively small braking torques generated by the electric drive unit act continuously on the stroller during the operation thereof. Merely by way of example here, these predetermined braking torques have a rectangular time curve. Other time progressions of the braking torques are likewise possible.

The absence of the user can preferably be identified by at least one negative acceleration value. A clear criterion for the absence of a user is hereby provided.

The presence of the user can preferably be identified by at least one positive acceleration value. Consequently, a clear criterion for detecting the presence of the user is provided, since the user force applied by the user and acting on the stroller results in positive acceleration values in the preferential pushing or pulling direction of the transport device.

In a technically favorable further development, the electric drive unit has an electric motor, in particular a brushless DC motor. Consequently, a practically maintenance-free drive for the transport device is provided.

In a further technically advantageous configuration, the electric drive unit has at least one gear. Simple adaptability of the given torque curve of the electric motor to specific requirements of the stroller operation is hereby possible.

According to a further favorable configuration, at least two wheels of the at least three wheels are designed as drive wheels, wherein an electric drive unit is associated with each of the at least two wheels in each case, wherein the electric drive units can be controlled independently of one another in each case by means of the control device. A symmetrical rear wheel or front wheel drive of the stroller can hereby be realized, wherein, with a suitable design of the control device, an electronic differential can be simultaneously realized to enable, amongst other things, cornering without notable friction losses at the drive wheels.

The at least one acceleration value can preferably substantially be recorded in a preferential primary pushing or pulling direction of the transport device by means of the at least one acceleration sensor. Consequently, only the main movement direction of the transport device or the stroller is used for the user-absence identification according to the invention. A further acceleration sensor can possibly be provided for two further spatial directions. Furthermore, at least one angular acceleration sensor in each case can be provided on the stroller for each axis of the three-dimensional space.

The present invention moreover relates to a method for identifying the presence of a user at a transport device, in particular at a stroller, having at least three wheels for moving on a surface and having a handle for the user, wherein at least one wheel of the at least three wheels is designed as a drive wheel which can be electromotively driven by means of an associated electric drive unit in order to enable at least partial electromotive support of a manual pushing or pulling operation of the transport device by the user on the surface. The following method steps are provided:

a. periodically applying predetermined braking torques to the transport device by means of the electric drive unit, which can be controlled by a control device, for temporarily braking the transport device,

b. recording acceleration values by means of at least one acceleration sensor associated with the transport device, and

c. evaluating the acceleration values of the at least one acceleration sensor by means of the control device, wherein, in the case of substantially negative acceleration values, the absence of the user is assumed and, with a further lack of a user force acting on the transport device, temporary braking of the transport device is continued until it reaches a standstill, or, in the case of substantially positive acceleration values, the presence of the user is assumed and the pushing or pulling operation in opposition to the predetermined braking torques is maintained or resumed due to a user force acting on the transport device.

A particularly simple and reliable method for user-absence identification at a stroller having electric support of the pushing or pulling operation can hereby be realized without additional sensor equipment.

On a surface which is inclined through an angle, an adaptation of a downhill force preferably takes place by recording a speed and a change in the speed of the electric drive unit. Consequently, inclined surfaces on which the stroller is moved can be taken into account. Owing to the recursive numerical adaptation or the successive approximation of the numerical value of the generally unknown (total) mass of the transport device, virtually the same traveling behavior of the transport device is ensured regardless of the angle at which the surface is inclined.

In the case of at least one negative acceleration unit, the predetermined braking torques are preferably increased non-linearly. As a result of this, a rapid cessation of the braking procedure of the stroller or the transport device is possible in a manner which does not impair the traveling comfort.

In a favorable further development of the method, an increase of the predetermined braking torques in the third power or according to another function takes place. As a result, a particularly reliable braking behavior of the stroller can be achieved. The alternative function can refer, for example, to a different power, a linear function, a ramp function etc.

In the case of a further configuration of the method, braking takes place by controlling the speed of the electric drive unit by means of the control device according to a speed curve which is independent of a mass of the transport device. The braking of the stroller can hereby be carried out on the basis of a previously defined speed curve, regardless of the (total) mass of the stroller.

### BRIEF DESCRIPTION OF THE DRAWINGS

The invention is explained in more detail in the description below, with reference to exemplary embodiments illustrated in the drawings, which show:

FIG. 1 a schematic side view of a transport device designed as a stroller, with user-absence identification according to the invention,

FIG. 2 a schematic illustration of a physical control path embodied by the stroller,

FIG. 3 a graph with a curve of a driving torque and an associated speed curve over time when identifying the presence of the user,

FIG. 4 a curve of a driving torque over time in the case of the absence of a user being identified,

FIG. 5 a curve of a driving torque over time for speed control by means of a speed curve in the case of the absence of the user being identified,

FIG. 6 a time curve of the speed of an electric drive unit, the first derivation of the speed, the second derivation of the speed and an associated curve of the driving torque of the electric drive unit over time,

FIG. 7 a schematic illustration of an adaptive speed control in the case of an inclined surface,

FIG. 8 a graph with a curve of the braking torque and an associated speed curve over time in the case of the adaptive speed control of FIG. 7.

### DETAILED DESCRIPTION

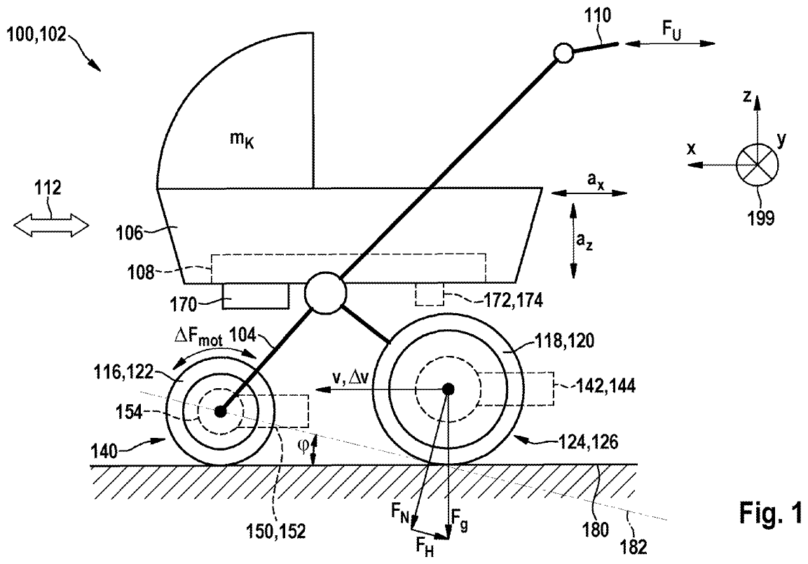

FIG. 1 shows a transport device 100 designed, merely by way of example, as a stroller 102. Alternatively, the transport device 100 can also be a wheelbarrow, a dolly, a waste disposal container, in particular a garbage can, a pallet truck or the like.

The stroller 102 has, by way of example, a collapsible chassis 104 and a bassinet or bucket seat 106 with a support 108 arranged therein for a child (not illustrated). A U-shaped and preferably ergonomically vertically adjustable handle 110 for a user of the stroller 102 (who is likewise not illustrated in the drawing) is preferably furthermore provided on the chassis 104. The stroller 100 preferably has at least three wheels 116, 118, 120. In this case, two wheels are preferably arranged on a rear axle and one wheel is arranged on a front axle, although two wheels can also be arranged on the front axle and one wheel can be arranged on the rear axle. At least one wheel of the at least three wheels 116, 118, 120 is preferably designed as a drive wheel 122, 124, 126. The at least one drive wheel 122, 124, 126 can preferably be electromotively driven by means of at least one electric drive unit 140, 142, 144. In this case, the at least one drive wheel 122, 124, 126 can be arranged on the front axle and/or the rear axle. At least two wheels are preferably designed as drive wheels 122, 124, 126.

Merely by way of example here, the stroller 102 has three wheels 116, 118, 120 of which, by way of example here, the front wheel 116 is designed as a drive wheel 22 which can be driven by means of the electric drive unit 140. At least partial electromotive support of a manual pushing or pulling operation of the stroller 102 in a preferred pushing or pulling direction 112 on a substantially horizontal surface 180 or on a surface 182 extending with an incline or slope through an angle φ with respect to said surface 180 takes place by means of the electric drive unit 140. The electric drive unit 140 here substantially preferably comprises an electric motor 150, which can be realized, for example, by a brushless, permanently excited DC motor 152 and preferably has a gear 154 for optimum speed and torque adaptation to the operating requirements of the transport device 100 or the stroller 102.

The drive unit 140 can preferably be controlled by means of an electronic control device 170.

Additionally or alternatively, the two rear wheels 118, 120, as described above, can also be designed as drive wheels 124, 126, wherein the drive wheels 124, 126 in such a configuration can be driven preferably individually in each case by means of an electric drive unit 142, 144 and controlled independently of one another with the aid of the control device 170 to realize the electromotively supported pushing or pulling operation of the stroller 102. For this purpose, the further electric drive units 142, 144 are preferably each equipped with an electric motor, in particular with a brushless, permanently excited DC motor and with a gear.

At least one acceleration sensor 172 is provided on the transport device 100 or the stroller 102 for the, here merely exemplary, recording of at least one acceleration value ax in the direction of the preferred pushing or pulling direction 112 of the stroller 102. Perpendicularly to the pushing or pulling direction 112 or perpendicularly to the surface 180, vertical acceleration values a_{z} of the stroller 102 can additionally be recorded by means of the acceleration sensor 172 or a further acceleration sensor 174. With the aid of further acceleration sensors and/or angular-acceleration sensors (not illustrated), it is furthermore possible to record acceleration values a_{y} perpendicularly to the plane of the drawing and any angular accelerations along and/or about the x-axis, the y-axis and the z-axis of the space, as indicated by the coordinate system 199, and to evaluate them in real time by means of the control device 170.

The establishment or the maintenance of the manual, at least partially electromotively supported, pushing or pulling operation is realized only when a user force Fu acts on the handle 110 of the stroller 102. The weight force F_{g}=m_{K}*g, which is independent of the electric drive unit 140, acts on the stroller 102, with m_{K} representing the generally unknown (total mass) of the stroller 102. In the case of the surface 182 being inclined through the angle φ, the weight force F_{g} is composed vectorially of a normal force FN and a downhill force F_{H} according to the relationship F_{H}=m_{K}*g*sin (φ), wherein the normal force FN acts perpendicularly to the inclined surface 182 and the downhill force F_{H} acts parallel thereto. Together with the user force F_{U}, the at least one drive unit 140 controlled by the control unit 170 brings about velocity changes Δv with respect to the current velocity v of the stroller 102.

According to the invention, small braking torques ΔFₘₒₜ predetermined by the control device 170 of the electric drive unit 140 can be periodically applied to the transport device 100 or the stroller 102, wherein the control device 170 is designed to evaluate the acceleration values ax of the at least one acceleration sensor 172 to identify the presence or the absence of a user and to preferably control the at least one electric drive unit 140 as a function thereof. In this context, repeatedly negative acceleration values aₓ preferably indicate the absence of the user, whereas the presence of the user can preferably be identified by at least one positive acceleration value aₓ.

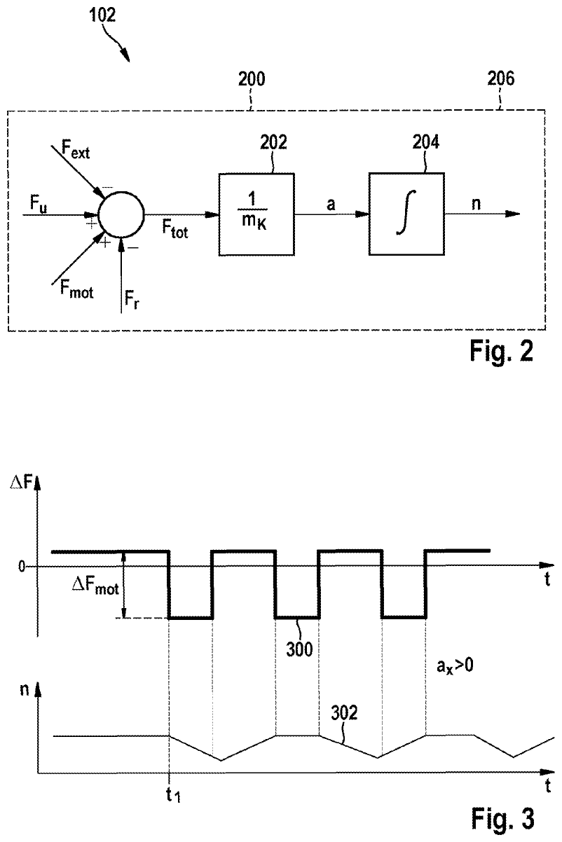

FIG. 2 shows a physical control path embodied by the stroller 102. Generally, negative external forces Fₑₓₜ and friction forces Fᵣ and positively acting forces Fₘₒₜ of the electric drive unit and the user force Fᵤ applied by the user act on a summation point 200, which forces add up vectorially to a resultant force Fₜₒₜ in the summation point 200. The friction forces Fᵣ or Fᵣ(n) are generally dependent on a current speed of the electric drive unit. The external forces Fₑₓₜ can be, for example, wind loads or trailer loads such as buggy boards, for example. A driving torque M_{A} to be applied by the electric drive unit 140 of the stroller 102 or a change in the driving torque ΔFₘₒₜ is produced due to the need for a force equilibrium of the forces acting on the stroller 102 according to the relationship M_{A}=ΔF=Fₘₒₜ+F_{U}+Fᵣ+Fₑₓₜ.

According to the equation Fₜₒₜ/m_{K}=a, with a known mass m_{K} of the stroller 102, a resultant (total) acceleration a of the stroller 102 as a consequence of all active forces can be derived in a computing stage 202 likewise reproduced by the stroller 102. After going through an integration stage 204 likewise embodied by the stroller 102, a necessary speed n of the electric drive unit 140 results from the acceleration a. Via their interaction, the summation point 200, the computing stage 202 and the integration stage 204 therefore form a control loop 206 for sufficiently precise physical modeling of the stroller 102 as a whole.

The equilibrium condition Fᵣ+Fₑₓₜ=ΔFₘₒₜ+F_{U} moreover applies for a constant velocity v of the stroller 102. If ΔFₘₒₜ now becomes abruptly negative and therefore triggers a braking torque ΔFₘₒₜ, the stroller 102 is braked, wherein the manner in which the braking of the stroller 102 takes place differs depending on the presence or absence of the user or optionally applied external forces Fₑₓₜ and can be evaluated, which is explained in more detail with reference to the following FIG. 3 to FIG. 5.

FIG. 3 shows an exemplary driving torque ΔF and an associated speed curve over time t when identifying the presence of the user. A first curve progression 300 shows the exemplary curve of the driving torque ΔF over time t together with the comparatively small, periodic, predetermined braking torques ΔFₘₒₜ. A second exemplary curve progression 302, which corresponds time-wise to the first curve progression 300, shows the curve of the speed of the at least one electric drive unit 140 of the stroller 102 over time t. The periodic action of the predetermined braking torque ΔFₘₒₜ results in a rectangular signal curve of the driving torque ΔF of the electric drive unit 140 over time t. Up to a point in time t₁, a constant driving torque ΔF firstly results in a constant speed n over time t. However, during the action of the predetermined braking torques ΔFₘₒₜ, the speed n decreases slightly in a linear manner to then increase linearly again to the starting value n after the cessation of the predetermined braking torque ΔFₘₒₜ. Consequently, a trapezoidal curve of the speed n over time t is established.

After the suspension of the predetermined braking torques ΔFₘₒₜ, it is checked by means of the control device 170 and an algorithm realized therein whether increasing or positive acceleration values ax are present. If this is the case, the presence of the user at the stroller 102 is to be assumed since the user force acts on the stroller 102 and, in the normal pushing or pulling operation, the user will always strive to counteract the braking torques ΔFₘₒₜ which are periodically predetermined by the control device. As a result of this, the existence of at least one positive acceleration value aₓ indicates the presence of the user at the transport device 100 or the stroller 102.

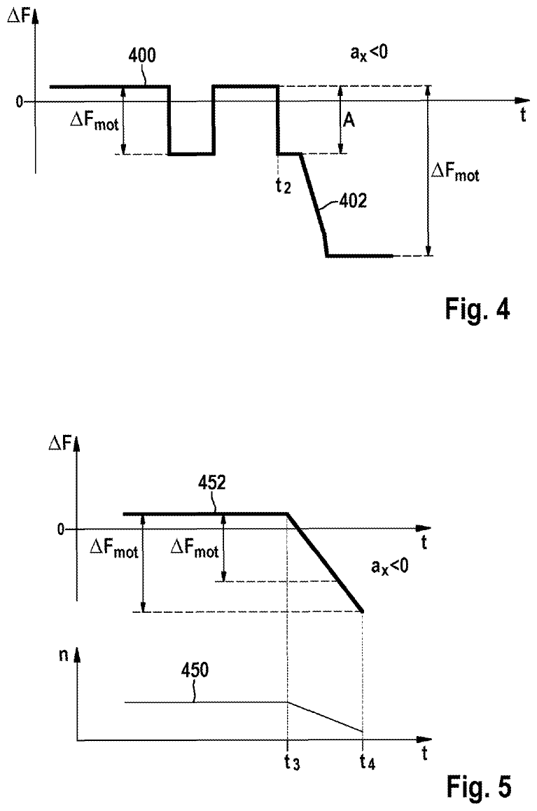

FIG. 4 shows an exemplary driving torque ΔF over time tin the case of the absence of the user being identified. A curve progression 400 indicates the curve of the driving torque ΔF over the time t with the preferably comparatively small, periodic, predetermined braking torques ΔFₘₒₜ. After the action of a given braking torque ΔFₘₒₜ, it can be checked by means of the control device 170 whether at least one positive acceleration value aₓ is present. If this is not the case or the at least one acceleration sensor 172, 174 determines at least one negative acceleration value aₓ from a point in time t₂, the absence of the user at the transport device 100 or the stroller 102 is to be assumed. In such a situation, according to a first alternative, the amplitude A of the braking torque ΔFₘₒₜ is increased adaptively from the point in time t₂, resulting in a comparatively over-proportionally sharp drop according to the third power in a curve section 402 of the driving torque ΔF. The adaptive increase in the braking torque ΔFₘₒₜ is preferably continued until the stroller 102 has come to a complete standstill or the user interrupts or overcomes this braking process by acting on the stroller 102 with the user force F_{U}.

FIG. 5 shows an exemplary driving torque ΔF over time t for speed control by means of a speed curve in the case of the absence of the user being identified. Due to the fact that the external forces acting on the stroller 102 and the (total) mass m_{K} of the stroller 102 are generally unknown, the braking procedure of the stroller 102 in the case of the absence of the user being identified can, in a deviation from FIG. 4, also take place according to a second alternative with the aid of a suitable speed curve 450 which is predetermined, for example, by the control device 170.

In the illustration of FIG. 5, as a result of at least one negative acceleration value aₓ, the absence of the user at the transport device 100 or the stroller 102 is again to be assumed. A curve progression 452 shows the curve of the driving torque ΔF and a predetermined braking torque ΔFₘₒₜ over time t. The speed curve 450 which is stored in the control device 170, for example, illustrates the curve of the speed n over time t. As shown by the curve progression 452, the braking torque ΔFₘₒₜ of the electric drive unit 140 is controlled with the aid of the speed curve 450 which is independent of the mass m_{K} of the stroller 102. Up to a point in time t₃, both the driving torque ΔF and the speed n over time t are constant. In the time range between a point in time t₃ and a point in time t₄, where t₄>t₃, the speed n is reduced linearly over time t in a manner controlled exclusively by the speed curve 450, which results in a likewise linear increase in the braking torque ΔFₘₒₜ over time t.

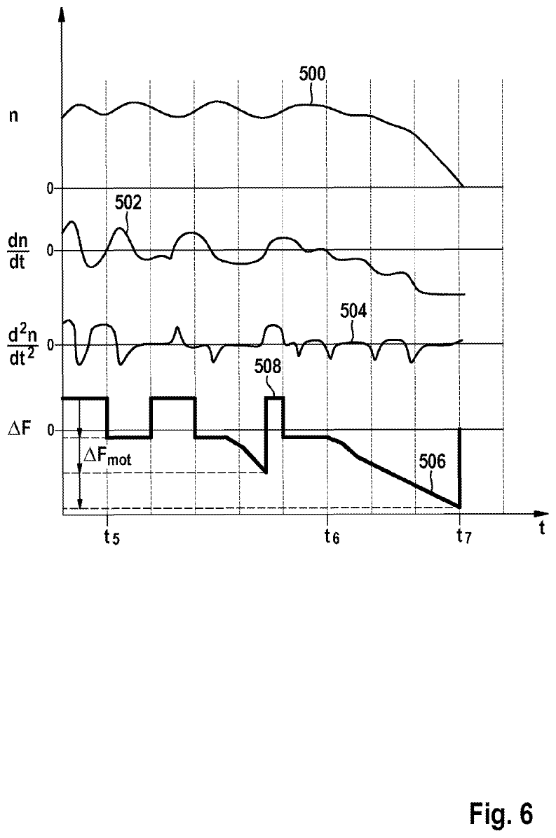

FIG. 6 shows an exemplary speed of an electric drive unit 140, the first derivation of the speed, the second derivation of the speed and an associated curve of the driving torque ΔF of the electric drive unit 140 over time t. Whilst the user is pushing or pulling the stroller 102, the small braking torques ΔFₘₒₜ predetermined by the control device 170 are as explained within the context of FIGS. 2 to 5 generated with the aid of the electric drive unit 140 which is likewise controlled by the control device 170. By means of the control device 170 and the at least one acceleration sensor 172, 174 of the stroller 102, it can be checked whether the stroller 102 is braked as a result of the small predetermined braking torques ΔFₘₒₜ or continues to move at a virtually constant velocity v. If braking or deceleration of the stroller 102 takes place, which can be detected via negative acceleration values aₓ, the braking torque ΔFₘₒₜ is increased in a controlled manner by the control device 170. The successive increase in the braking torques ΔFₘₒₜ takes place analogously to the graphs in FIGS. 4 and 5, which are explained above, until the stroller 102 has come to a complete standstill or the user, via the reapplication of a possibly slightly increased user force F_{U} for overcoming the braking process, accelerates the stroller 102 again so that positive acceleration values aₓ can be detected.

A first curve progression 500 shows the speed n of the at least one electric drive unit 140 of the stroller 102 over time t. A second curve progression 502 illustrates the first derivation dn/dt of the speed n according to time t, a third curve progression 504 represents the second derivation d²n/dt² thereof according to time t and a fourth curve progression 506 shows the corresponding curve of the driving torque ΔF of the electric drive unit 140 with the periodic braking torques ΔFₘₒₜ predetermined by the control device 170, again over time t.

If the first derivation of the speed n over time t becomes substantially less than zero, as shown by the curve progression 502 in the region of the point in time t₅, the braking procedure commences and, if the second derivation of the speed n over time is greater than zero, as shown by the curve progression 504, the braking procedure is interrupted, as shown by way of example by a curve section 508. Otherwise, from a point in time t₆, the braking torque ΔFₘₒₜ is preferably increased linearly, approximately in the form of a ramp, according to the curve progression 506. If the speed n reaches zero, as shown by the first curve progression 500, the braking torque ΔFₘₒₜ can be removed, that is to say the braking torque ΔFₘₒₜ preferably reaches the level of the zero line again from a point in time t₇, as shown by the curve progression 506.

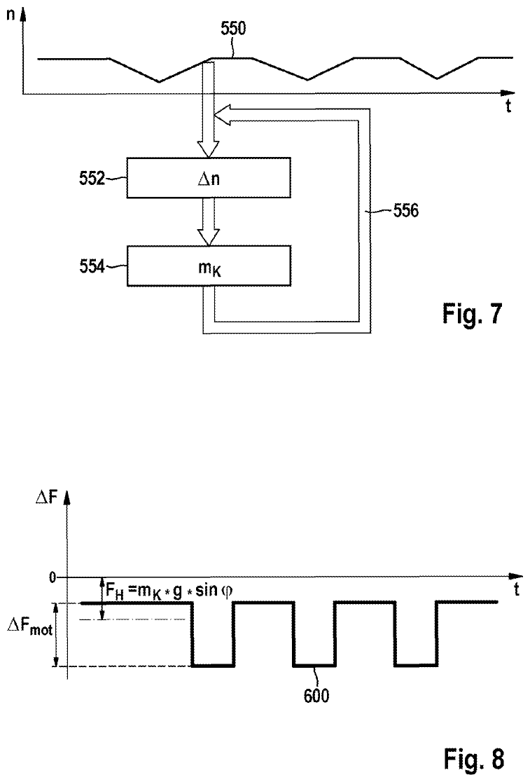

FIG. 7 shows an exemplary adaptive speed control in the case of an inclined surface. To ensure that the behavior of the stroller 102 on a surface which is inclined through the angle φ is the same as on a horizontal surface, the downhill force would need to be optionally compensatable, which is hardly practicable under the real usage conditions of the stroller 102 or the transport device 100 (c.f. in particular FIG. 1, reference signs 180, 182, φ, F_{H}). Therefore, in the case of the transport device 100 or the stroller 102, automatic adaptation by means of the control device 170 is provided.

An approximately trapezoidal curve progression 550 is illustrated by the curve of the speed n of the at least one electric drive unit 140 of the stroller 102 over time t. The empirical compensation of the downhill force F_{H} takes place preferably via automatic adaptation (recursion) by means of a suitable algorithm implemented in the control device 170. The equilibrium condition M_{A}=ΔF=Fₘₒₜ+F_{U}+Fr+Fₑₓₜ−F_{H} firstly applies on the inclined surface, with the downhill force according to the equation F_{H}=m*g*sin (φ). Since the mass m_{K} of the transport device 100 or the stroller 102 is not constant, amongst other things owing to the generally unknown mass m_{K} of the different goods or occupants being transported, and is therefore unknown, but all other variables are known, the unknown mass m_{K} can be approximately determined by way of the empirical adaptation. For this purpose, a time variation Δn of the speed n of the at least one electric drive unit 140 of the stroller 102 is preferably firstly recorded in a first processing stage 552 and undergoes analysis or comparison in a second processing stage 554 which follows the first processing stage 552.

Depending on the result of this analysis or comparison, with each run, the numerical value of the mass m_{K} of the stroller 102 is moreover preferably successively numerically adapted in the second processing stage 554 in that it is reduced, increased or maintained. If Δn is greater than zero, the numerical value of m_{K} is reduced within the second processing stage 554, if Δn is less than a limit value Δnₘₐₓ predetermined by the second processing stage 554, the numerical value of m_{K} is increased and, in the event that a condition Δn<0 and Δn>Δnₘₐₓ is fulfilled, the numerical value of m_{K} remains constant in that it is unchanged in the second processing stage 554. The new, correspondingly modified numerical value for m_{K}, which is better approximated in such a way in the second processing stage 554, is supplied to the first processing stage 552 via a feedback branch 556. This recursive feedback procedure is run multiple times for the optimum approximation of the numerical value of m_{K} stored in the control device 170 to the actual physical (total) mass of the stroller 102, wherein it is constantly checked how the braking action or the value of Δn changes. The two processing stages 552, 554, including the feedback branch 556, can be realized for example by means of a suitable algorithm within the control device 170 of the stroller 102.

FIG. 8 shows an exemplary curve of the braking torque ΔFₘₒₜ and an associated speed curve over time t in the case of the adaptive speed control of FIG. 7. A curve progression 600 represents the curve of the driving torque ΔF over time t including the predetermined braking torques ΔFₘₒₜ . The downhill force F_{H} follows the equation F_{H}=m*g*sin (φ) and acts according to the relationship ΔF=Fₘₒₜ+F_{U}+Fᵣ+Fₑₓₜ−F_{H} merely as a constant negative offset in relation to the curve progression 600 of the driving torque ΔF including the modulated braking torques ΔFₘₒₜ .

In a further continuation of the description, the method according to the invention for identifying the presence or absence of the user solely on the basis of the algorithmic evaluation of acceleration values aₓ of at least one acceleration sensor 172, 174 which is sensitive in the primary pushing or pulling direction of the transport device 100 or the stroller 102 by means of the control device 170 shall be explained in detail with simultaneous reference to FIG. 1 to FIG. 8. In a method step a), periodic application of small predetermined braking torques ΔFₘₒₜ to the transport device 100 takes place with the aid of the electric drive unit 140 which can be controlled by a control device 170, for at least temporarily braking the transport device 100 or the stroller 102. In a subsequent method step b), the recording of acceleration values ax takes place by means of at least one acceleration sensor 172 suitably positioned on the transport device 100 or on the stroller 102. In this case, by means of the at least one acceleration sensor 172, accelerations aₓ in the preferred pushing or pulling direction 112 of the transport device 100 are preferentially determined continuously and preferably with comparatively high measuring accuracy. At least one further acceleration sensor 174 can be provided on the transport device 100, for example to record acceleration values a_{z} perpendicularly to the horizontal surface 180 and to supply them to the control device 170 for numerical evaluation. In a final method step c), the evaluation of the acceleration values aₓ of the at least one acceleration sensor 172 takes place by means of the preferably electronic, fully digital control device 170. In the case of substantially negative acceleration values aₓ, the absence of the user is assumed in this case. With a further lack of a user force F_{U} acting on the transport device, the temporary braking of the transport device 100, in particular for safety reasons, is continued until it reaches a complete standstill.

According to a first method alternative, in the case of at least one negative acceleration value aₓ, the predetermined braking torques ΔFₘₒₜ can be increased non-linearly or over-proportionally so that, if the user is possibly absent, the stroller 102 is braked quickly and reliably until it reaches a standstill. The increase in the predetermined braking torques ΔFₘₒₜ can take place, for example, in the third power or according to any other mathematical function, e.g. a linear or quadratic function or a ramp function. In a second possible method variant, it is provided that braking is carried out by controlling the speed of the at least one electric drive unit 140 by means of the control device 170 on the basis of a speed curve 450 which is independent of the mass m_{K} of the transport device 100 or the stroller 102.

If substantially positive acceleration values aₓ are present, it is assumed, on the other hand, that the user is present, so that the pushing or pulling operation of the transport device 100 in opposition to the minimal braking action of the comparatively small, predetermined braking torques ΔFₘₒₜ is maintained or resumed as a result of a user force F_{U} acting on the transport device 100. In the case of a surface 182 which is inclined through the angle φ in relation to the horizontal surface 180, a numerical, recursive adaptation of the downhill force F_{H} is carried out by recording a change in the speed Δn of the at least one electric drive unit 140. Consequently, it is ensured that the transport device 100 or the stroller 102 exhibits the same travelling behavior for the user both on the horizontal surface 180 and on a surface 182 inclined through the angle φ.

1. A transport device (100) having at least three wheels (116, 118, 120) for moving on a surface (180, 182) and having a handle (110) for a user, wherein at least one wheel (116, 118, 120) of the at least three wheels (116, 118, 120) is designed as a drive wheel (122, 124, 126) which can be electromotively driven by means of an associated electric drive unit (140, 142, 144) in order to enable at least partial electromotive support of a manual pushing or pulling operation of the transport device (100) by the user on the surface (180, 182), wherein at least one acceleration sensor (172, 174) is provided on the transport device (100) and a predetermined braking torque (ΔFₘₒₜ ) can be periodically applied to the transport device (100) during the pushing or pulling operation by the electric drive unit (140, 142, 144), wherein a control device (170) associated with the at least one acceleration sensor (172, 174) is configured to evaluate the acceleration values (ax) of the at least one acceleration sensor (172, 174) to identify the presence or absence of a user at the transport device (100) and to control the electric drive unit (140, 142, 144) as a function thereof.

2. The transport device as claimed in claim 1, wherein the absence of the user can be identified by at least one negative acceleration value (aₓ).

3. The transport device as claimed in claim 1, wherein the presence of the user can be identified by at least one positive acceleration value (aₓ).

4. The transport device as claimed in claim 1, wherein the electric drive unit (140) has an electric motor (150).

5. The transport device as claimed in claim 4, wherein the electric drive unit (140) has at least one gear (154).

6. The transport device as claimed in claim 1, wherein at least two wheels (116, 118, 120) of the at least three wheels (116, 118, 120) are configured as drive wheels (122, 124, 126), wherein an electric drive unit (140, 142, 144) is associated with each of the at least two wheels (116, 118, 120) in each case, wherein the electric drive units (140, 142, 144) can be controlled independently of one another in each case by the control device (170).

7. The transport device as claimed in claim 1, wherein the at least one acceleration value (aₓ) can be substantially recorded in a preferential primary pushing or pulling direction (112) of the transport device (100) by the at least one acceleration sensor (172, 174).

8. A method for identifying the presence of a user at a transport device (100) having at least three wheels (116, 118, 120) for moving on a surface (180, 182) and having a handle (110) for the user, wherein at least one wheel (116, 118, 120) of the at least three wheels (116, 118, 120) is configured as a drive wheel (122, 124, 126) which can be electromotively driven by an associated electric drive unit (140, 142, 144) in order to enable at least partial electromotive support of a manual pushing or pulling operation of the transport device (100) by the user on the surface (180, 182), including steps:
periodically applying predetermined braking torques (ΔFₘₒₜ ) to the transport device (100) by means of the electric drive unit (140, 142, 144), which can be controlled by a control device (170), for temporarily braking the transport device (100),
recording acceleration values (aₓ) by at least one acceleration sensor (172, 174) associated with the transport device (100), and
evaluating the acceleration values (ax) of the at least one acceleration sensor (172, 174) by the control device (170), wherein, in the case of substantially negative acceleration values (aₓ), the absence of the user is assumed and, with a further lack of a user force (F_{U}) acting on the transport device (100), temporary braking of the transport device (100) is continued until it reaches a standstill, or, in the case of substantially positive acceleration values (aₓ), the presence of the user is assumed and the pushing or pulling operation in opposition to the predetermined braking torques (ΔFₘₒₜ) is maintained or resumed as a result of a user force (F_{U}) acting on the transport device (100).

9. The method as claimed in claim 8, wherein on a surface (182) which is inclined through an angle (φ), an adaptation of a downhill force (F_{H}) takes place by recording a speed (n) and changing the speed (Δn) of the electric drive unit (140, 142, 144).

10. The method as claimed in claim 8, wherein, in the case of at least one negative acceleration unit (aₓ), the predetermined braking torques (ΔFₘₒₜ ) are increased non-linearly.

11. The method as claimed in claim 10, wherein an increase in the predetermined braking torques (ΔFₘₒₜ ) in the third power or according to another function takes place.

12. The method as claimed in claim 8, wherein braking takes place by controlling the speed of the electric drive unit (140, 142, 144) by the control device (170) according to a speed curve (452) which is independent of a mass (m_{K}) of the transport device (100).

13. The method as claimed in claim 8, wherein the transport device comprises a stroller (102).

14. The method as claimed in claim 9, wherein braking takes place by controlling the speed of the electric drive unit (140, 142, 144) with the control device (170) according to a speed curve (452) which is independent of a mass (m_{K}) of the transport device (100).

15. The transport device (100) as claimed in claim 1, wherein the transport device comprises a stroller (102).

16. The transport device as claimed in claim 4, wherein the electric motor (150) comprises a brushless DC motor (152).
